(19) United States
(12) Patent Application Publication
(10) Pub. No.: US 2016/0098795 A1
(43) Pub. Date: Apr. 7, 2016

(54) Path-Dependent Market Risk Observer

(71) Applicant: Mehmet Alpay Kaya, Indian Shores, FL (US)

(72) Inventor: Mehmet Alpay Kaya, Indian Shores, FL (US)

(21) Appl. No.: 14/504,760

(22) Filed: Oct. 2, 2014

(51) Int. Cl. G06Q 40/06

(52) U.S. Cl. CPC G06Q 40/06

(57) ABSTRACT

A computerized method is presented for observing the market risk of a portfolio, which includes application of path-dependent analysis to market data and providing risk observations capturing salient characteristics of risk experienced by investors. Advantages of one or more embodiments include support for accurate estimation of probabilities associated with large losses and expected losses at given probabilities. The method is adaptable to all risk estimation functions and is compatible with nonhomogeneous data.

### CROSS REFERENCE TO RELATED APPLICATIONS

This application does not contain a reference to any other application.

### FEDERALLY SPONSORED RESEARCH OR DEVELOPMENT

The research and development activities serving as the foundation of the invention were conducted with no Government support.

### JOINT RESEARCH AGREEMENT

There is no joint research agreement applicable to the invention. The research and development activities serving as the foundation of the invention were conducted independently by the sole named inventor.

### PRIOR DISCLOSURES BY THE INVENTOR

During a presentation given on 3 Oct. 2013, the inventor claimed the probability of a loss by a future point in time is greater than the probability of the same loss at that same future point in time and displayed a slide of value evolution trajectories in support of this claim. During a telephone conversation on 8 Jan. 2014, the inventor made the same claim and sent the same slide by electronic mail to an individual partaking in the conversation.

### BACKGROUND OF THE INVENTION

The following United States patent appears to be relevant at present.

United States Patents

| Document | Issue Date | Inventor |
|---|---|---|
| 7,870,052 B1 | 2011 Jan. 11 | Goldberg et al. |

The following United States patent application appears to be relevant at present.

United States Patent Applications

| Document | Publication Date | Applicant |
|---|---|---|
| 2008/0262884 A1 | 2008 Oct. 23 | Muller |

The following tabulation lists, in reverse chronological order, prior art among nonpatent literature that appears to be relevant at present.

Nonpatent Literature

Chen, James Ming; “Measuring Market Risk under the Basel
Accords”; Aestimatio; Instituto de Estudios Bursatiles;
Volume 8, pages 184-201; March 2014.
“Revisions to the Basel II Market Risk Framework”; Basel
Committee on Banking Supervision; Bank for
International Settlements; February 2011.

Owing to a series of actions taken in the public and private sectors beginning in the early 1980s, value-at-risk (VaR) became and has remained the archetypal metric for market risk analysis in Finance. The market risk of a portfolio is the risk of loss due to changes in market prices. Because of the highly uncertain price dynamics in financial markets, a statistical approach is a natural choice. The framework used herein divides market risk analysis into two steps: observation and estimation. These steps are executed by an observation function and an estimation function. An estimation function acts on observations, which are the output of an observation function. An observation function acts on the market data of a portfolio. The analysis time interval is the period over which market risk is analyzed.

The estimation function VaR is introduced first to provide a familiar starting point. In the present disclosure, VaR is defined as a portfolio return satisfying a probability constraint:

VaR(X(tₙ),p)=inf(cεR|F(X(tₙ),c)≧p) (EQ. 1)

the VaR return over analysis time interval tₙ at probability p of a portfolio subject to return random variable X equals the real-valued infimum c such that the cumulative density function (CDF) of X evaluated at c is greater than or equal to p. An infimum is a greatest lower bound and may be understood to mean minimum by the casual reader. The terms VaR return, VaR limit, and VaR threshold are used interchangeably herein.

The observation function implied by EQ. 1 is portfolio return, which may be understood to be a function of initial and final price. Market risk is analyzed by estimation function VaR acting on observations that are output by the observation function. From a canonical point of view, market data should be provided by a distribution of random prices from which return can be calculated by the observation function. In practice, the distribution is specified to provide returns.

Value-at-risk in EQ. 1 is an expression of a quantile function. Quantile is a generalized ranking function, and if its parameter has a quantization of 0.01, it is equivalent to a percentile.

To illustrate EQ. 1, consider return random variable X to be normally distributed with 4% mean and 20% volatility over the analysis time interval. A 5% VaR return over time tₙ

VaR(X(tₙ),p)=F⁻¹(normal,0.05)=0.04-1.65(0.20)=−0.29 (EQ. 2)

equals the inverse of a normal CDF evaluated at 0.05, which is consistent with a return 1.65 standard deviations lower than mean return. The value of c in EQ. 2 is −0.29 and represents the ‘border’ between the smallest 5% of returns and the rest of the distribution. It also means there is a 5% chance portfolio return will be lower than the VaR limit. A lower value for c, −0.35 for example, would violate the inequality in EQ. 1. A greater value for c, −0.20 for example, would not qualify as an infimum because it is not a lower bound (there exist lower values satisfying the inequality).

The definition of VaR in the present disclosure is not standard. Some publications define VaR as a positive number representing loss, creating a disconnect between written explanations and the natural form of equations. Sometimes VaR analysis is parametrized on a confidence level while failing to specify the analysis as being one- or two-tailed. The notation used herein allows for the most consistency between exposition and equations and supports a full, clear, and concise disclosure.

The definition of VaR used herein also allows for convenient expression of an associated VaR growth factor,

y(VaR(X(tₙ),p))=exp(VaR(X(tₙ),p)) (EQ. 3)

the exponential function acting on VaR return. A growth factor is the ratio of final value to initial value over some time interval implied by its VaR return argument and should be understood to be a normalized price. The exponential function in EQ. 3 implies use of a logarithmic return price model but should not be misunderstood to imply assumption of a log-normal return distribution.

As mentioned, market risk analysis comprises an estimation function acting on the output of an observation function. The observation function, portfolio return over the analysis time interval, acts on market data of the portfolio, which may be simulated or historical. Three popular methods for providing market data are summarized below, all of which are familiar to a person having ordinary skill in Risk Management.

(a) The Analytical method makes use of an assumed probability distribution as a source of market data. The distribution is typically defined so as to directly provide return observations rather than prices (from which returns may be calculated by an observation function). In the illustrative example (see EQ. 2) return observations were generated by the normal distribution.

(b) The Historical method uses the historical prices of assets, which may be of daily, weekly, or some other frequency.

(c) The Monte Carlo method uses an assumed probability distribution to generate interim returns, which propagate simulation of the value of the portfolio over the analysis time interval. This provides a value series over the analysis time interval, and this value series is one sample of market data. The number of samples of market data provided by this method equals the number of times the simulation is run, often in the range from 1000 to 100,000.

Current industry practice comprises estimation methods published by the Bank for International Settlements (BIS) in various Basel Accords. The stressed VaR estimate employs a probability distribution representative of market dynamics during times of crisis. The accords also outline methods for applying a safety factor to VaR estimates and averaging VaR estimates. Partial expectation is being adopted by BIS to provide an estimate of the typical loss incurred if the portfolio return is lower than the VaR limit. The colloquial term expected shortfall has supplanted partial expectation in the financial lexicon. As all of these methods describe estimation functions acting on the output of observation functions, they are affected by the present disclosure.

Research by academics in Mathematics and Statistics has focused on the characteristics of various estimation functions, including but not limited to quantile, partial expectation, and expectile. The details of that research are not discussed here, but an accessible survey is provided by Chen. As that body of work is concerned with estimation functions acting on the output of observation functions, it is affected by the present disclosure.

Common to all prior art is the assumption of path-independence in regards to portfolio risk; the path of portfolio values is ignored. In other words, they assume all information related to portfolio risk is embedded in the return observation at the end of the analysis time interval. Some prior art has considered varying time intervals but conform to this assumption. The work of Goldberg et al. provided for efficient generation of path-independent estimates parametrized on time. The work of Muller provided for adapting to fixed time intervals data collected at varying time intervals.

The market risk analysis methods heretofore known suffer from a number of disadvantages.

(a) All erroneously categorize market risk as a path-independent phenomenon.

(b) VaR return, as it is currently calculated, significantly underestimates the probability of a portfolio experiencing large losses.

(c) Partial expectation, building on an underestimated VaR return, in turn underestimates the expected loss of a portfolio at a given probability.

### SUMMARY OF THE INVENTION

In accordance with one embodiment, a computer-implemented method for structuring a market risk observer comprises accessing market data of a portfolio, applying path-dependent analysis to the market data, and providing risk observations.

Several advantages of one or more aspects are as follows: observations of risk representative of the experience of investors, risk estimates that accurately predict the probability of large losses, and accurate estimates of expected losses at given probabilities. Other advantages of one or more aspects will be apparent from a consideration of the drawings and ensuing description.

### DRAWINGS

FIG. 1 illustrates graphs of two value evolution trajectories.

FIG. 2 illustrates histograms of return and risk observations.

FIG. 3 illustrates graphs of the cumulative distribution functions of return and risk observations.

FIG. 4 illustrates graphs of the left side of the cumulative distribution functions of return and risk observations.

The following tabulation lists reference numbers appearing in the drawings.

| | |
|---|---|
| 110 VaR Trajectory | 120 PDVaR Trajectory |
| 130 VaR Threshold | |
| 210 Return Histogram | 220 Risk Histogram |
| 310 Return CDF | 320 Risk CDF |

### DETAILED DESCRIPTION

A Path-Dependent Market Risk Observer uses path-dependent observation functions to provide risk observations capturing salient characteristics of portfolio assets throughout the analysis time interval.

### First Embodiment

The method of the present disclosure in accordance with one embodiment includes generating risk observations from market data. The market data of a portfolio has been generated by a Monte Carlo simulation covering an analysis time interval of 63 days. Interim returns in the form of daily logarithmic returns were sampled from a normal distribution with zero mean and 1% volatility. For each sample of market data, 63 daily returns were used by the exponential function to propagate simulation of the value of the portfolio over 63 days. Each sample of market data is a value trajectory represented as a vector with 64 elements. Each value trajectory is normalized by its initial value. The set of market data is comprised of 5000 trajectories. The method of the first embodiment accesses this market data.

Although by their very nature investment portfolios are presumed to have positive mean return, zero mean serves as a conservative assumption consistent with current practice. The analysis time interval of three months is not the most popular, but some firms perform supplementary risk analyses to match their financial reporting schedule. Neither parameter affects the universality of the present disclosure.

Calculate the maximum loss associated with each value trajectory. Because the initial value of each trajectory is +1, the natural logarithm (base e) of any value in a trajectory equals the cumulative return of that trajectory to that point in time. Calculate the natural logarithm of the minimum value of each trajectory. These 5000 values, comprised of the lowest interim cumulative return associated with each trajectory, comprise a set of observations of risk random variable Q. This set is also referenced by the term risk observations. The minimum cumulative return function is the observation function in this embodiment.

Estimation functions such as quantile and partial expectation can be applied to the set of risk observations. The 250th lowest member of the risk observations is the worst loss an investor will experience with 95% probability. The average of the 250 lowest risk observations provides the partial expectation at 5% probability.

Several selections were specified as part of this embodiment. The number of simulations (5000), the interim time discretization (1 day), and the statistical distribution chosen are used to specify the Monte Carlo simulation used to generate market data. As Monte Carlo simulations are studied and used routinely in Finance, a person having ordinary skill in Risk Management has the capability of making these selections. The analysis time interval is 63 days, and a person having ordinary skill in Risk Management has the capability of selecting an analysis time interval.

### Operation

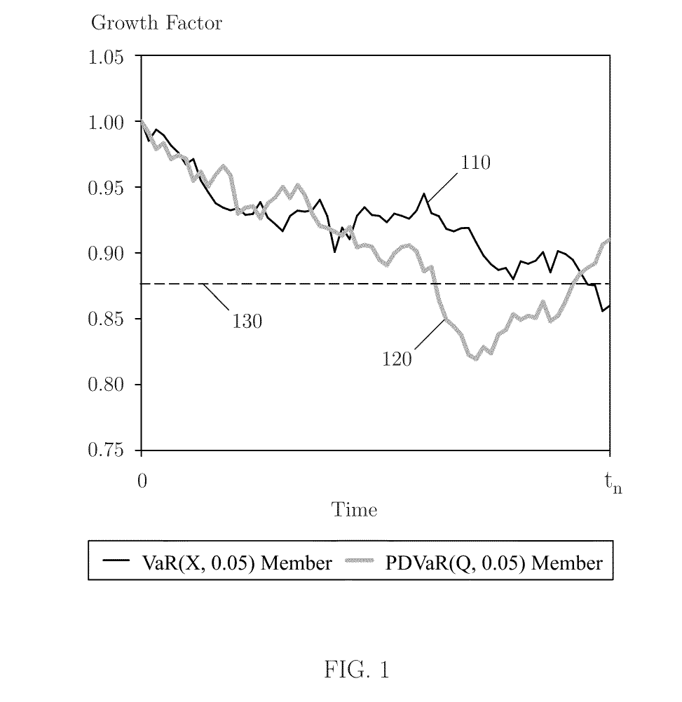

Consider the market risk analysis introduced in the first embodiment. In FIG. 1 are shown the graphs of two exemplary value trajectories from the market data of the portfolio. VaR Trajectory 110 shows the value trajectory for a return observation satisfying the prior art definition of VaR. In other words, the cumulative return over the 63-day interval is within the lowest 5% of all observations of cumulative return random variable X. PDVaR Trajectory 120 shows the value trajectory for a risk observation consistent with the first embodiment. Its minimum cumulative return during the 63-day interval is lower than the Path-Dependent VaR (PDVaR) limit, within the lowest 5% of all risk observations. VaR Threshold 130 shows the value associated with the prior art 5% VaR limit. Note the final value of PDVaR Trajectory 120; it is higher than VaR Threshold 130.

In FIG. 1, it is clear that PDVaR Trajectory 120 shows larger interim losses than VaR Trajectory 110 during the analysis time interval. Because the final value of PDVaR Trajectory 120 is greater than VaR Trajectory 110, it is characterized by all prior-art market risk analyses as showing less risk. It is interesting to note the return volatilities, often used as a measure of risk, of the two graphs: 0.99% for VaR Trajectory 110 and 1.09% for PDVaR Trajectory 120. Prior art risk analysis associates less risk with the trajectory showing a larger maximum loss and higher volatility. This is at odds with what an investor experiences during the analysis time interval.

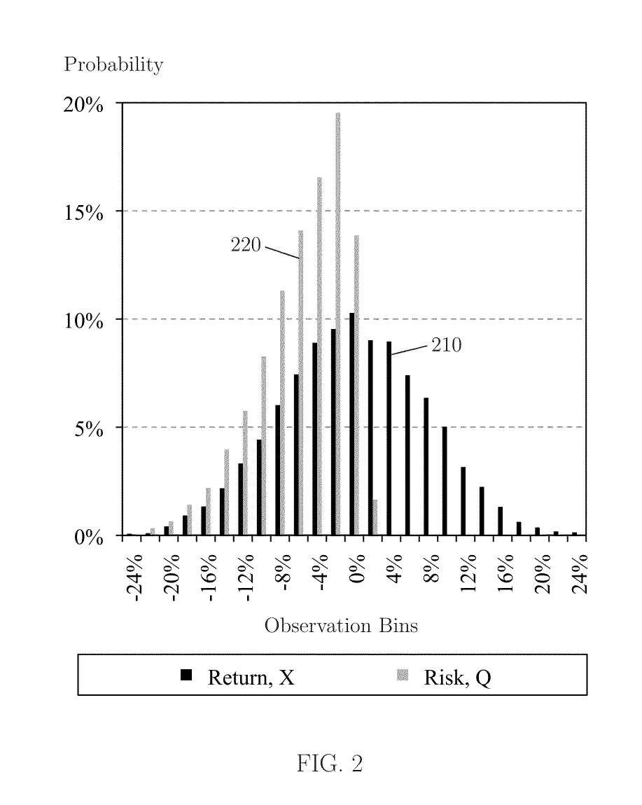

In FIG. 2 are shown both Return Histogram 210 and Risk Histogram 220. The observation bins have width of 2% and are centered on the indicated value. For example, 8.9% of return and 16.6% of risk observations fall into the bin labeled −4% (between −3% and −5%). Return Histogram 210 shows a shape consistent with the normal distribution assumption of the market data. Risk Histogram 220 shows that almost every trajectory experiences a loss at some point in time.

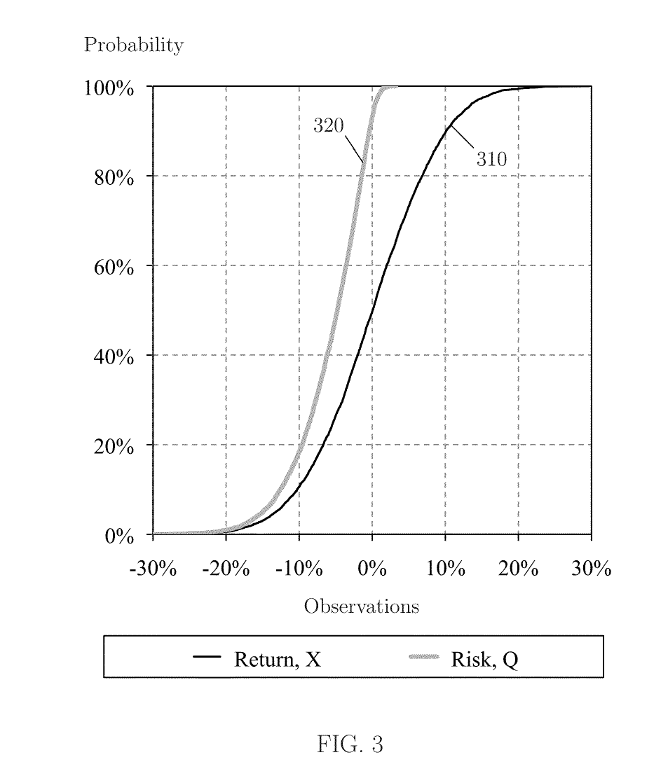

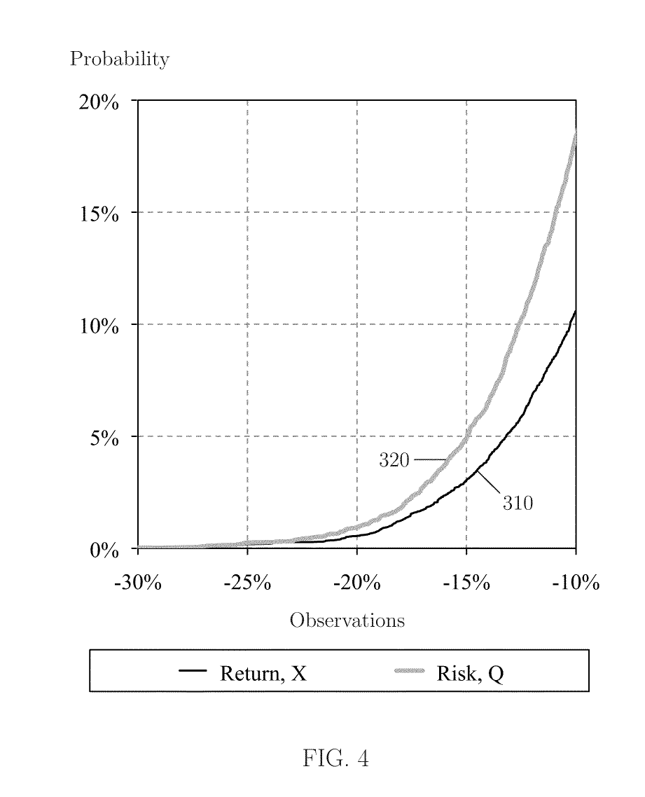

In FIG. 3 are shown both Return CDF 310 and Risk CDF 320. The graphs show the probability of an observation lower than the indicated value. Return CDF 310 shows a 10.6% probability of a return lower than −10% at the end of 63 days. Risk CDF 320 shows an 18.4% probability of an investor experiencing a return lower than −10% at some point during those same 63 days. FIG. 4 shows a close-up view of the left side of FIG. 3. Risk observations categorically lead to higher probabilities associated with large losses; as such, risk observations differ from prior art in kind.

For the market data of the first embodiment,

VaR(X(tₙ=63 days),p=0.05)=−0.132 (EQ. 4)

the 5% VaR limit of return random variable X equals −13.2%. A path-dependent value-at-risk (PDVaR) estimate is determined by the same quantile function (confer EQ. 1) acting on risk random variable Q:

PDVaR(Q(tₙ=63 days),p=0.05)=−0.150 (EQ. 5)

the 5% PDVaR limit equals −15.0%. In the set of risk observations, the quantile ranking of −13.2% is 0.085. Over 8% of trajectories show a loss of at least 13.2% at some point, painting a different picture than the 5% VaR threshold. The partial expectation at 5% probability shows similar relative results: −16.5% for return X and −18.0% for risk Q. Prior art underestimates risk on a consistent basis.

As mentioned, three months is not a typical period over which to estimate risk. If the first embodiment covered one day divided into 63 sub-periods, the relative results between prior art and the present disclosure would be the same. The results shown are typical. Path-dependent analysis makes use of additional information found in the individual trajectories.

By rejection of the path-independence assumption, risk observations allow for statistical analysis of losses experienced by investors throughout an analysis time interval. Risk observations allow emphasis to be placed on the salient characteristics of risk. In other words, investors are concerned with the probability of losing a certain amount of money and the loss associated with a certain probability. Prior art subjugates these concerns to a point-in-time constraint. If investors are concerned with the state of a portfolio at a point in time, those investors will be concerned with the state of the portfolio at all times leading up to that same point in time.

Path-dependent behavior is prevalent in the physical sciences, including but not limited to thermal energy losses due to friction. Mathematical models of such phenomena make use of path-dependent functions. The assumption of path-dependence in structuring a risk observer does not qualify as encompassing substantially all uses of a physical phenomenon. The use of any function modeling path-dependence does not qualify as covering all substantial practical uses of a mathematical relationship.

### Additional Embodiments

In accordance with another embodiment, the method of structuring a risk observer comprises the use of the maximum drawdown function as an observation function. This takes into account the loss of profits made during the analysis time interval. If PDVaR Trajectory 120 in FIG. 1 first increased to 1.05 before dropping to its minimum value of 0.82, the maximum drawdown risk observation would be calculated as the return associated with the drop in value from 1.05 to 0.82.

In accordance with another embodiment, the method of structuring a risk observer comprises access to market data at intervals equal to the analysis time interval; in other words, without the interim data available in the first embodiment. Consider estimating one-day risk given daily data as a non-limiting example. Historical data often includes daily high and daily low prices in addition to daily close prices. Calculate daily risk as the return associated with the change in price from the close price one day to the low price the following day. This calculation is referred to as close2 min return herein.

In accordance with another embodiment, the method of structuring a risk observer comprises access to market data at intervals equal to the analysis time interval; in other words, without the interim data available in the first embodiment. Consider estimating one-day risk given daily data as a non-limiting example. Historical data often includes daily high and daily low prices with time stamps in addition to daily close prices. On days when the high price occurs after the low price, calculate daily risk as the return associated with the change in price from the high price that day to the low price the following day. On days when the high price occurs before the low price, calculate daily risk as the return associated with the change in price from the close price that day to the low price the following day. This calculation is referred to as maxclose2 min return herein.

### Ramifications

From the preceding description, a number of advantages of one or more embodiments of the Path-Dependent Market Risk Observer are evident.

(a) Path-dependent risk observations convey the experience of investors more accurately than path-independent return observations.

(b) The probability associated with a given loss and the loss associated with a given probability are most accurately estimated by path-dependent analysis.

(c) Risk observations support the accuracy of risk estimation functions, including but not limited to the quantile and partial expectation functions.

(d) The path-dependent observation functions, including but not limited to minimum cumulative return and maximum drawdown, used in the present disclosure allow for efficient use of nonhomogeneous market data. Prior art risk analysis, constraining time to fixed intervals, cannot adapt easily to data input with irregular frequency.

The method for observing market risk has the additional advantages in that it supports the following variations.
(a) Market data accessed may include interim data at a frequency other than daily.

(b) Market data accessed may include interim data at irregular frequency.

(c) Data may be accessed in different ways, including but not limited to retrieval from non-transitory computer-readable media and online subscription service.

(d) Data may be provided in different ways, including but not limited to saving to non-transitory computer-readable media and output to a computer software module.

(e) Market data comprises different information, including but not limited to return data and price data. Market data may be historical or simulated.

### Scope

Further embodiments in accordance with the present disclosure include non-transitory computer-readable media comprising computer-readable instructions to control a computer to perform the steps described herein.

Although multiple embodiments have been described, it should be understood that various modifications and adaptations may be made without deviating from the rationale and purview of the present disclosure. As such, the specification and drawings are to be accepted as exemplifying rather than limiting in nature.

1. A method implemented by a computer for observing market risk, comprising:
a. accessing, with said computer, market data of a portfolio over an analysis time interval;
b. generating a set of market risk observations by evaluating a path-dependent observation function over said market data; and
c. providing, with the computer, said set of market risk observations;
d. wherein said path-dependent observation function calculates market risk within said analysis time interval; and
e. wherein the computer comprises a non-transitory, computer-readable storage medium having computer-executable instructions recorded thereon that, when executed on the computer, configure the computer to perform said method.

2. The method of claim 1, wherein the path-dependent observation function is minimum interim cumulative return.

3. The method of claim 1, wherein the path-dependent observation function is maximum drawdown return.

4. The method of claim 1, wherein the path-dependent observation function is close2 min return.

5. The method of claim 1, wherein the path-dependent observation function is maxclose2 min return.

6. The method of claim 1, wherein the path-dependent observation function is time-weighted average value return.

7. A method implemented by a computer, comprising:
a. accessing market data of a portfolio, said market data comprising a plurality of portfolio value trajectories;
b. for each of said plurality of portfolio value trajectories, generating a market risk observation;
c. aggregating said market risk observations to generate a market risk distribution of said portfolio; and
d. providing said market risk distribution;
e. wherein each of the plurality of portfolio value trajectories spans an analysis time interval;
f. wherein the market risk observation is generated by evaluating a path-dependent function; and
g. wherein said computer comprises a non-transitory, computer-readable storage medium having computer-executable instructions recorded thereon that, when executed on the computer, configure the computer to perform said method.

8. The method of claim 7, wherein said path-dependent function is minimum interim cumulative return.

9. The method of claim 7, wherein said path-dependent function is maximum drawdown return.

10. The method of claim 7, wherein said path-dependent function is close2 min return.

11. The method of claim 7, wherein said path-dependent function is maxclose2 min return.

12. The method of claim 7, wherein said path-dependent function is time-weighted average value return.

13. A method implemented by a computer, comprising:
a. accessing a value trajectory of a portfolio;
b. generating a market risk observation; and
c. providing said market risk observation;
d. wherein said value trajectory spans an analysis time interval;
e. wherein the market risk observation is generated by evaluating a path-dependent function; and
f. wherein said computer comprises a non-transitory, computer-readable storage medium having computer-executable instructions recorded thereon that, when executed on the computer, configure the computer to perform said method.

14. The method of claim 13, wherein said path-dependent function is minimum interim cumulative return.

15. The method of claim 13, wherein said path-dependent function is maximum drawdown return.

16. The method of claim 13, wherein said path-dependent function is close2 min return.

17. The method of claim 13, wherein said path-dependent function is maxclose2 min return.

18. The method of claim 13, wherein said path-dependent function is time-weighted average value return.
